(19) United States
(12) Patent Application Publication
(10) Pub. No.: US 2016/0053167 A1
(43) Pub. Date: Feb. 25, 2016

(54) FLUORESCING MCHM BLEND FOR FACILITATING DETECTION IN THE EVENT OF A SPILL

(71) Applicant: Spectronics Corporation, Westbury, NY (US)

(72) Inventors: Jonathan Cooper, Lloyd Harbor, NY (US); Jennifer Hunt, Holbrook, NY (US)

(73) Assignee: SPECTRONICS CORPORATION, Westbury, NY (US)

(21) Appl. No.: 14/466,543

(22) Filed: Aug. 22, 2014

(51) Int. Cl. C09K 11/06; G01N 21/64; G01M 3/20

(52) U.S. Cl. CPC C09K 11/06; G01M 3/20; G01N 21/64; C09K 2211/1011; C09K 2211/1029; G01N 2201/061

(57) ABSTRACT

A 4-Methylcyclohexanemethanol and fluorescent dye blend. The fluorescent dye selected from a group consisting of a naphthalimide dye, a perylene dye, and combinations thereof. In one embodiment, the mixture includes a polyol ester oil, a petroleum hydrocarbon and a naphthalimide dye. The fluorescent dye may further comprise a mineral oil, and a perylene dye.

### FIELD OF THE INVENTION

The invention relates to oil blends and, more particularly, to a crude 4-methylcyclohexanemethanol (MCHM) fluorescent blend that facilitates detection during leakage or a spill.

### BACKGROUND

Coal is still an important fuel source in the United States. Because coal contains many other mining ores, it must be cleaned and purified prior to being sold. Coal generally goes through a three step process that includes roughing, cleaning, and scavenging. In the roughing step, the coal is ground up into tiny bits. In the second or cleaning step, surfactants (frothing agents) are used along with other chemicals to drive off the various impurities from the coal. This is all based around hydrophobicity and hydrophilicity. The typical frothing agent is 4-Methylcyclohexanemethanol (MCHM). When brought into contact with the frothing agent, the finely divided coal particles adhere to air bubbles and rise to the surface. The third step is scavenging which involves further purification of the coal.

Chemical spills, including oil spills, pose a major environmental hazard. Not only is the clean-up costly, but the harm to the eco-system (land, water and animals) may not be correctable for years, and in some cases it may not be fully correctable at all. For example, there was a recent major chemical spill in January 2014 in which crude MCHM was released from a facility into the Elk River in West Virginia. Crude MCHM is a mixture of various compounds. 4-methylcyclohexanemethanol (MCHM) is the major component of crude MCHM. As mentioned above, crude MCHM is a chemical foam typically used to wash coal and remove impurities that contribute to pollution during combustion. The spill involved up to 7,500 US gallons of crude MCHM that leaked from a one-inch hole in the bottom of a stainless steel storage tank and into its containment area located around the tank. The crude MCHM then leaked from the containment area into the ground, through which it traveled into the nearby Elk River.

The spill occurred upstream from a principal West Virginia intake and treatment and distribution center. As much as 300,000 residents within nine counties in the Charleston, West Virginia metropolitan area were forced to be without access to potable water for considerable time while the spill was cleaned up.

Once the oil is spilled into the ground, water and even a treatment center, it becomes difficult to detect. A system that permits the early detection of an MCHM spill or leakage would be beneficial.

### SUMMARY OF THE INVENTION

A crude 4-methylcyclohexanemethanol (MCHM) fluorescent blend that facilitates detection of the MCHM in the event of a leak or spill. In one embodiment, the fluorescent blend is a mixture of 4-Methylcyclohexanemethanol and a fluorescent dye. The fluorescent dye is preferably selected from a group consisting of a naphthalimide dye, a perylene dye, and combinations thereof. In one formulation, the fluorescent dye is a naphthalimide dye mixed with polyol ester oil and a petroleum hydrocarbon. A mineral oil and a perylene dye may be added to that blend.

Preferably the blend has a ratio of fluorescent dye to the 4-Methylcyclohexanemethanol of about 1 part fluorescent dye to at least about 512 parts 4-Methylcyclohexanemethanol. The amount of 4-Methylcyclohexanemethanol may be between about 512 and about 1024 parts 4-Methylcyclohexanemethanol to the one part fluorescent dye.

In one embodiment, a dye additive is provided for use with 4-Methylcyclohexanemethanol. The dye additive is designed to fluoresce upon illumination by a light source emitting light having a wavelength of less than or equal to about 500 nm. Preferably the dye additive is a mixture of a polyol ester oil, a petroleum hydrocarbon, and a naphthalimide dye. The dye additive may also include a mineral oil, and a perylene dye.

A process is also disclosed for forming a 4-Methylcyclohexanemethanol blend capable of fluorescing upon illumination by a light source emitting light having a wavelength of less than or equal to about 500 nm. The process involved the steps of providing a 4-Methylcyclohexanemethanol; and adding a fluorescent dye to the 4-Methylcyclohexanemethanol, the fluorescent dye being selected from a group consisting of a naphthalimide dye, a perylene dye, and combinations thereof.

The fluorescent dye may comprise a polyol ester oil, a petroleum hydrocarbon, and a naphthalimide dye, and optionally may include a mineral oil and a perylene dye.

A process for detecting a 4-Methylcyclohexanemethanol spill is disclosed. The process involves providing a 4-Methylcyclohexanemethanol and fluorescent dye blend, and, upon determining a site of a potential spill, illuminating the site with a light source emitting light having a wavelength of less than or equal to about 500 nm. The light source will cause the fluorescent dye in the 4-Methylcyclohexanemethanol to fluoresce thereby identifying the location of the spill.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### DESCRIPTION OF THE PREFERRED EMBODIMENTS

4-Methylcyclohexanemethanol (MCHM), or more appropriately 4-methylcyclohexylmethanol, is an organic compound with the formula CH₃C₆H₁₀CH₂OH. Classified as an alcohol, it exists as two isomers with similar properties. MCHM is a colorless chemical. As such, it would be difficult to detect upon leakage from a tank or containment housing. The inventors have determined that MCHM alone does not fluoresce when exposed to ultraviolet, violet or blue lights. Thus, it cannot be detected even with the use of fluorescent lighting, thus making it difficult to detect once it has infiltrated into the ground, water or elsewhere.

The present invention contemplates the addition of a fluorescent dye to the MCHM which can be detected upon illumination with a suitable light source. The dye is selected such that it stays miscible in the MCHM, does not adversely affect the properties of the MCHM, and is less chemically toxic than the MCHM. The inventors analyzed and tested multiple dye additives for use with MCHM. Two fluorescent dye additives were determined to produce a beneficial fluorescence when combined in an appropriate amount with MCHM. The first is a perylene-based fluorescent dye which produces an intense yellow fluorescent response when exposed to incident radiation in a band of the electromagnetic spectrum which includes the long wave ultraviolet (UV-A) wavelength range of about 315 nm to about 400 nm, with a strong peak between about 340 to 375 nm. Long-wave ultraviolet is also referred to as “black light”, as it includes a small segment of the visual violet range. Yellow perylene-based dye is typically provided as a dye solution comprising a yellow fluorescing perylene-based compound and an oil, with the yellow fluorescing perylene-based compound comprising from about 17 to about 50 weight % of the dye solution.

The second fluorescent dye additive that has been found to work in MCHM is a naphthalimide-based dye which fluoresces a brilliant green when exposed to incident radiation of visible violet/blue light. The visible violet/blue range extends from about 400 nm to about 480 nm within the electromagnetic spectrum. Yellow perylene-based dyes and green naphthalimide-based dyes can also be mixed to produce a dye blend which will fluoresce red when exposed to UV/violet/blue light.

After significant testing using different fluorescent dyes, the inventors were able to determine a combination of dyes that would work best in MCHM. Table 1 lists the different fluorescent dyes sold by Spectronics Corporation under the trademark OIL-GLO® that the inventors determined could be used with MCHM. Table 2 summarizes some of the test results using the various fluorescent dyes under different lights conditions.

TABLE 1
Fluorescent compositions

| Dye Type | Dye Base | Additives |
|---|---|---|
| OIL-GLO 22 | perylene | mineral oil |
| OIL-GLO 30 | perylene, | polyol ester oil, |
| | naphthalimide | aromatic |
| | and coumarin | |
| OIL-GLO 33 | naphthalimide | polyol ester oil, |
| | | aromatic |
| OIL-GLO 40 | naphthalimide | polyol ester oil, |
| | and coumarin | aromatic |
| OIL-GLO 44 | perylene and | polyol ester oil, |
| | naphthalimide | aromatic |
| OIL-GLO 50 | perylene | mineral oil |

TABLE 2
Fluorescent Response For Different Dyes When Viewed Under Different
Light Sources (With And Without Fluorescent Enhancing Glasses)

| | | | | 400 nm with | | 450 nm with |
|---|---|---|---|---|---|---|
| Dye Type | Dye Base | 365 nm | 400 nm | UVS-40 glasses | 450 nm | UVS-40 glasses |
| OIL-GLO 22 | perylene | Highly Visible | Not Visible | Visible | Not Visible | Visible |
| OIL-GLO 30 | perylene, | Highly Visible | Visible | Highly Visible | Visible | Highly Visible |
| | naphthalimide | | | | | |
| | and coumarin | | | | | |
| OIL-GLO 33 | naphthalimide | Highly Visible | Highly Visible | Highly Visible | Highly Visible | Highly Visible |
| OIL-GLO 40 | naphthalimide | Highly Visible | Visible | Highly Visible | Not Visible | Highly Visible |
| | and coumarin | | | | | |
| OIL-GLO 44 | perylene and | Highly Visible | Visible | Visible | Not Visible | Highly Visible |
| | naphthalimide | | | | | |
| OIL-GLO 50 | perylene | Highly Visible | Not Visible | Barely Visible | Not Visible | Visible |

Thus, depending on the wavelength of light used, the present invention can be used with varying types of naphthalimide and perylene dyes and produce a visible response.

The testing did show that one preferred blend which provides a highly visible response is a blend of polyol ester oil, mineral oil, perylene dye, petroleum hydrocarbon, and naphthalimide dye sold by Spectronics Corporation under the trademark OIL-GLO® 44 fluorescent dye. Another dye blend embodiment blend provides a highly visible response is a blend of polyol ester oil, petroleum hydrocarbon, and naphthalimide dye sold by Spectronics Corporation under the trademark OIL-GLO® 33 fluorescent dye. In both cases, the fluorescent dye was miscible in the MCHM and did not show any signs of precipitate or other abnormalities that would be indicative of incompatibility between the dye and the MCHM.

In conducting the testing, the OIL-GLO dye was diluted into the MCHM and then illuminated with various light sources. Specifically, one ounce of OIL-GLO dye was added to four gallons of MCHM. However, it has been determined that as little as one ounce of OIL-GLO dye could be added to eight gallons or more gallons of MCHM and still achieve a suitable fluorescence. One of the benefits of OIL-GLO dye is that it dilutes or mixes well with the MCHM.

The present invention uses a light source configured to emit light so as to cause a fluorescent response in the fluorescent dye and MCHM mixture when exposed to incident radiation in a band of the electromagnetic spectrum which includes the long wave ultraviolet (UV-A) wavelength range (about 315 nm to about 400 nm) through the visible violet/blue range (from about 400 nm to about 480 nm) within the electromagnetic spectrum. In the preferred embodiment, the light source is designed to emit light in a wavelength between about 365 nm and about 450 nm.

As mentioned above, crude MCHM is used in the second step to clean the coal. The binding of the OIL-GLO and crude MCHM should be such that, upon cleaning of the coal, the MCHM and dye combination should be washed off. Any remnants of OIL-GLO dye that remain on the coal should, upon burning of the coal, turn into ash. The OIL-GLO dye itself is non-toxic. As such, the addition of the OIL-GLO dye to the MCHM will result in a product that is no more toxic to the environment than the MCHM alone.

The present invention contemplates that the fluorescent dye would be added to the MCHM prior to or during its placement in the storage tanks or other storage containers. To determine if there is any leakage from the containers, an inspector can shine a suitable light source, such as a light source emitting blue, violet, or UV spectrum light, for example, the OPTIMAX™ 365 lamp manufactured by Spectronics Corporation, around the storage container or tank. If the MCHM is leaking the fluorescent dye will begin to brightly fluoresce, thus permitting prompt detection. The fluorescent response of the dye can be enhanced with the use of UV enhancing glasses.

Another benefit to the incorporation of the fluorescent dye with the MCHM is that, in the event that there is a spill, the extent of the MCHM spill can be quickly determined by illuminating likely spill areas with the UV, violet or blue light to try to detect any fluorescence. This permits clean-up crews to quickly detect and contain the MCHM spill in water and soil, and also permits inspectors to determine if components, such as filters in water treatment plants, have been compromised. After the spill has been contained and initial cleaning has been conducted, the area can be illuminated again with the UV, violet or blue light to determine if any remnants of the MCHM can be detected.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

1. A 4-Methylcyclohexanemethanol and fluorescent dye blend, the fluorescent dye being selected from a group consisting of a naphthalimide dye, a perylene dye, and combinations thereof.

2. The blend of claim 1 wherein the fluorescent dye is a naphthalimide dye mixed with polyol ester oil and a petroleum hydrocarbon.

3. The blend of claim 3 wherein the fluorescent dye further comprises a mineral oil and a perylene dye.

4. The blend of claim 1 wherein the ratio of fluorescent dye to the 4-Methylcyclohexanemethanol is about 1 part fluorescent dye to at least about 512 parts 4-Methylcyclohexanemethanol.

5. The blend of claim 2 wherein the ratio of fluorescent dye to the 4-Methylcyclohexanemethanol is about 1 part fluorescent dye to at least about 512 parts 4-Methylcyclohexanemethanol.

6. The blend of claim 3 wherein the ratio of fluorescent dye to the 4-Methylcyclohexanemethanol is about 1 part fluorescent dye to at least about 512 parts 4-Methylcyclohexanemethanol.

7. The blend of claim 1 wherein the ratio of fluorescent dye to the 4-Methylcyclohexanemethanol is about 1 part fluorescent dye to between about 512 and about 1024 parts 4-Methylcyclohexanemethanol.

8. The blend of claim 2 wherein the ratio of fluorescent dye to the 4-Methylcyclohexanemethanol is about 1 part fluorescent dye to at least about 512 parts 4-Methylcyclohexanemethanol.

9. The blend of claim 3 wherein the ratio of fluorescent dye to the 4-Methylcyclohexanemethanol is about 1 part fluorescent dye to between about 512 and about 1024 parts 4-Methylcyclohexanemethanol.

10. A process for forming a 4-Methylcyclohexanemethanol blend capable of fluorescing upon illumination by a light source emitting light having a wavelength of less than or equal to about 500 nm, the process comprising the steps of
providing a 4-Methylcyclohexanemethanol; and
adding a fluorescent dye to the 4-Methylcyclohexanemethanol, the fluorescent dye being selected from a group consisting of a naphthalimide dye, a perylene dye, and combinations thereof.

11. The process of claim 10 wherein the fluorescent dye comprises a polyol ester oil, a petroleum hydrocarbon, and a naphthalimide dye.

12. The process of claim 11 wherein the fluorescent dye further comprises a mineral oil and a perylene dye.

13. The process of claim 10 wherein the fluorescent dye is added to the 4-Methylcyclohexanemethanol in a ratio of about 1 part fluorescent dye to between about 512 and about 1024 parts 4-Methylcyclohexanemethanol.

14. The process of claim 10 wherein the fluorescent dye is added to the 4-Methylcyclohexanemethanol in a ratio of about 1 part fluorescent dye to at least about 512 parts 4-Methylcyclohexanemethanol.

15. The process of claim 11 wherein the fluorescent dye is added to the 4-Methylcyclohexanemethanol in a ratio of about 1 part fluorescent dye to between about 512 and about 1024 parts 4-Methylcyclohexanemethanol.

16. The process of claim 11 wherein the fluorescent dye is added to the 4-Methylcyclohexanemethanol in a ratio of about 1 part fluorescent dye to at least about 512 parts 4-Methylcyclohexanemethanol.

17. The process of claim 12 wherein the fluorescent dye is added to the 4-Methylcyclohexanemethanol in a ratio of about 1 part fluorescent dye to between about 512 and about 1024 parts 4-Methylcyclohexanemethanol.

18. The process of claim 12 wherein the fluorescent dye is added to the 4-Methylcyclohexanemethanol in a ratio of about 1 part fluorescent dye to at least about 512 parts 4-Methylcyclohexanemethanol.

19. A process for detecting a 4-Methylcyclohexanemethanol spill, the process comprising the steps of
providing a 4-Methylcyclohexanemethanol and fluorescent dye blend according to claim 1; and
upon determining a site of a potential spill, illuminating the site with a light source emitting light having a wavelength of less than or equal to about 500 nm, the light source causing the fluorescent dye in the 4-Methylcyclohexanemethanol to fluoresce thereby identifying the location of the spill.
